(19) United States
(12) Patent Application Publication
(10) Pub. No.: US 2011/0073046 A1
(43) Pub. Date: Mar. 31, 2011

(54) System for controlling animal noise

(76) Inventor: Billy Fischer, Hamshire, TX (US)

(21) Appl. No.: 12/586,638

(22) Filed: Sep. 25, 2009

(51) Int. Cl. A01K 15/00

(52) U.S. Cl. 119/718; 119/721

(57) ABSTRACT

Systems and methods for controlling animal noise, for example, by preventing and/or deterring the barking of dogs, are described herein. A water source is provided in communication with an animal enclosure, such that the water source is configured to provide water to the interior of the enclosure. An audio sensor is disposed proximate to and/or within the enclosure, in communication with the water source. Responsive to detection of animal noise within the enclosure, the audio sensor causes transmission of a signal to cause the water source to provide water into the enclosure, thereby deterring the animal noise. The systems and methods can utilize one or more selected sensitivity/volume thresholds, and can also include a timing mechanism for regulating the length of time that the water is provided.

### FIELD

The present invention relates, generally, to systems and methods usable to control animal noise, and in specific embodiments of the invention, to automatic systems and methods usable to deter dog barking and similar animal sounds through providing water to the interior of an animal enclosure responsive to an audio sensor.

### BACKGROUND

When retaining animals, indoors or outdoors, the noise produced by such animals can be a significant consideration. This is especially noteworthy when keeping multiple, highly active animals, such as hunting dogs, and when retaining animals close to one or more residences, where animal noise may disrupt sleep and other routine activities, create a disturbance, and incur complaints from neighbors.

Numerous devices exist to control specific animal noises, such as dog barking, however the large majority of such devices are unsuitable for controlling multiple animals simultaneously, and can utilize methods that are unpleasant, and possibly dangerous, for the animal. For example, existing devices include dog collars adapted to deliver an electrical shock to a barking dog, responsive to detection of vibrations within the dog's neck. Other collar-mounted devices include devices that spray citronella or other substances that provide scents repulsive to dogs, or cold fluids that provide unpleasant physical sensations to the dog, responsive to a vibration sensor. Additional devices designed to control dog barking include both collar-mounted and remote devices configured to provide a high frequency sound responsive to detection of barking, the unpleasant sound being intended to deter dogs from continued noise.

A need exists for systems and methods for controlling dog barking and other animal noises that is usable to deter animal noise from multiple animals within an enclosure, simultaneously.

A need also exists for systems and methods for controlling dog barking and other animal noises that utilize methods that are both humane and harmless to the animals, such as spraying the animals with water.

A further need exists for systems and methods for controlling dog barking and other animal noises that are customizable, enabling preselection of noise tolerances and/or durations, and the duration of noise deterrent.

A need exists for wear-resistant systems and methods that are usable to deter animal noise without use of a collar or other article that must be attached to the animal, which can be prone to extreme wear depending on the animal's activities.

The present invention meets these needs.

### SUMMARY

The present invention relates, generally, to a system for controlling animal noise. The system includes an enclosure adapted for containing one or more animals, having a water source disposed in communication therewith. In a preferred embodiment of the invention, the enclosure can include a kennel adapted for containing one or more dogs. However, it should be understood that the present invention is usable with any type of enclosure intended to contain any number and any type of animal.

The enclosure can be placed in communication with any type of water source, including public or private water sources, community water sources, wells, reservoirs, or separate discrete water sources, such as one or more tanks or similar water carrying vessels. Any type or configuration of hoses, tubes, piping, pumps, or the like, as known in the art, can be used to operably connect the water source with the enclosure such that water can be provided to the interior of the enclosure.

In an embodiment of the invention, one or more valves, which can include automatic valves, can be disposed in communication with the water source to control the flow of water to the enclosure. In a further embodiment of the invention, one or more nozzles or similar distribution mechanisms can be positioned within or proximate to the enclosure to provide controlled distribution of water to one or more regions of the enclosure. Adjustable nozzles or similar devices can be used to modify the direction, quantity, and force of the water provided to the enclosure.

An audio sensor is disposed proximate to or within the enclosure, the audio sensor being placed in direct or wireless communication with the water source, and/or one or more valves or nozzles. Various types of noise and/or sound sensors are known in the art and are usable within the scope of the invention. Responsive to detection of animal noise, such as the bark of a dog or a similar animal call, the audio sensor transmits a signal to the water source, causing water to be provided to the interior of the enclosure in a manner intended to deter animal noise.

The audio sensor can contain any manner of processor, data storage, computer instructions, transmitters, receivers, and/or other related components or circuitry usable to detect noise and transmit signals responsive to sounds. In an embodiment of the invention, the audio sensor can include a preselected and/or customizable tolerance usable to control transmission of the signal, such that a detected noise, of a volume that does not meet or exceed the selected tolerance, will not cause a signal to be transmitted to the water source. This embodiment of the invention is useful in outdoor areas and other locations where background and/or ambient noise or other extraneous sounds may be present, and it is desirable to avoid the provision of water to the enclosure when the enclosed animals are not producing noise.

In a further embodiment of the invention, the system can further include a timing mechanism in communication with the water source, the audio sensor, or combinations thereof, configured to provide water to the interior of the enclosure for a preselected period of time, such as thirty seconds.

In operation, the present system can be provided to an animal enclosure, such as by attaching one or more nozzles, hoses, or other distribution members to the walls and/or ceiling of a kennel or similar enclosure. A noise originating within the enclosure is detected, such as through use of an audio sensor, as described above. If the audio sensor is provided with a preselected tolerance, the detected noise can be disregarded if it fails to meet or exceed a selected volume based on the preset or customized tolerance. Responsive to the noise, a signal is transmitted by the audio sensor, which causes water to be provided to the interior of the enclosure.

Water is provided such that animals within the enclosure are deterred from continuing to make noise. In an embodiment of the invention, the water can be provided for a preselected period of time, such as through use of a timing device, at which point provision of the water will discontinue unless additional noise is detected during and/or at the completion of the preselected period of time.

The present invention thereby provides for systems and methods for automatically controlling animal noise, including barking of dogs, by mounting components within and/or proximate to an animal enclosure, enabling multiple animals to be controlled simultaneously through use of a single system. Use of prior art devices would require purchase and provision of individual collar-mounted devices to each animal retained, each device being subject to wear and damage, requiring frequent replacement, depending on the activities of the animal. Additionally, the present invention provides for a manner of deterring animals from creating noise through use of water, which is significantly less dangerous and more humane than conventional use of electrical shock, sonic devices, and/or chemicals.

### BRIEF DESCRIPTION OF THE DRAWINGS

In the detailed description of various embodiments of the present invention presented below, reference is made to the accompanying drawings, in which:

FIG. 1 depicts an embodiment of the present system.

FIG. 2 depicts a diagram of an embodiment of various components of the present system.

Embodiments of the present invention are described below with reference to the listed Figures.

### DETAILED DESCRIPTION OF THE EMBODIMENTS

Before explaining selected embodiments of the present invention in detail, it is to be understood that the present invention is not limited to the particular embodiments described herein and that the present invention can be practiced or carried out in various ways.

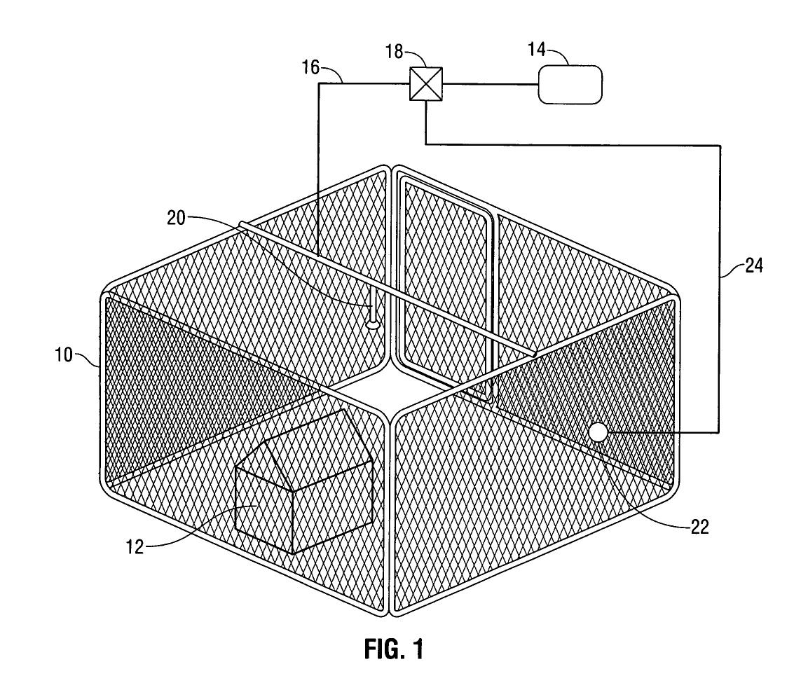

Referring now to FIG. 1, an animal enclosure (10) is depicted, having an interior animal structure (12) within, for use by an animal to avoid inclement weather and other conditions within the enclosure (10). While FIG. 1 depicts a single animal enclosure (10) having a structure (12) for use by a single animal, it should be understood that embodiments of the present invention are usable within an enclosure of any size, able to retain any number and any type of animal. Further, embodiments of the present invention are usable to provide water to multiple enclosures simultaneously, or to discrete areas of a single enclosure having multiple animal retention areas, each containing one or more animals.

FIG. 1 further depicts a source of water (14) in communication with the enclosure (10). The source of water (14) can include, without limitation, any number of public, private, natural, or manmade sources of water, as well as reservoirs and/or discrete tanks or other vessels for retaining water. A connecting member (16) is shown communicating the source of water (14) with the enclosure (10). The connecting member (16) can include any type or configuration of pipes, tubing, hoses, pumps, valves, and other similar members and devices, necessary to flow water from the source of water (14) to the enclosure (10).

A valve (18) is shown disposed between the source of water (14) and the enclosure (10) for controlling the flow of water to the enclosure (10). The valve (18) can include any type of valve, such as a check valve, a gate valve, a butterfly valve, a ball valve, a globe valve, a plug or needle valve, or other types of valves, clamps, or similar apparatuses able to restrict and/or inhibit the flow of fluid between the source of water (14) and the enclosure (10). The valve (18) can include an automatic and/or remotely actuatable valve, able to be opened and closed responsive to a signal, without requiring manual manipulation or control by a user.

The connecting member (16) is shown terminating within the enclosure (10) at a nozzle (20), which is oriented to provide water from the water source (14) to one or more portions of the interior of the enclosure (10). While FIG. 1 depicts a single nozzle (20) disposed within the top of the enclosure (10), embodiments of the invention can include any type and any number of nozzles, spraying devices, or other distribution members positioned on, along, within, or exterior to any portion of the enclosure (10).

An audio sensor (22) is shown disposed within the enclosure (10) secured to one of the walls. The audio sensor (22) can include any type of device equipped with a microphone or similar sound detecting mechanism of sufficient sensitivity to detect an animal noise from within the enclosure (10). While FIG. 1 depicts a single audio sensor (22) secured to a wall of the enclosure (10), it should be understood that the present invention can include any number and any type of audio sensor, disposed within or external to the enclosure (10), oriented such that animal noises from within the enclosure (10) can be detected.

The audio sensor (22) is shown in direct communication with the valve (18) using wiring (24). In various embodiments of the invention, the audio sensor (22) can be in direct or wireless communication with the valve (18), the water source (14), the nozzle (20), or any mechanism therebetween. The audio sensor (22) can include various integral or remote processors, data storage media, transmitters, receivers, circuitry, and/or computer instructions usable to detect animal noise, transmit a signal responsive to the animal noise, enable selection of a tolerance which must be met or exceeded by a noise prior to transmitting the signal, or combinations thereof. Similarly, the audio sensor (22), water source (14), valve (18), or nozzle (20) can include a timing mechanism, directly or wirelessly coupled with any necessary circuitry and/or computer instructions to enable selection of a predetermined time period for provision of water to the enclosure (10), and causing the provision of water for the selected time period.

In operation, when an animal within the enclosure (10) produces noise in excess of the tolerance of the audio sensor (22), the audio sensor (22) detects this animal noise and transmits a signal via the wiring (24) to the valve (18). Responsive to the signal, the valve (18) opens, enabling water to flow from the water source (14) through the connecting member (16) to the nozzle (20), where the water is distributed within the enclosure (10) in a manner that it will contact the animal. Many animals, especially various breeds of dog, will cease producing noise responsive to the water, and will return to the covered structure (12) to avoid contact with the water. In this manner, any number of animals within the enclosure (10), and within any number of enclosures having audio sensors provided in communication with the water source (14), can be simultaneously deterred from barking or producing other similar noises, through a single implementation of the present system. Prolonged use of the present system can train dogs or other animals to cease barking or making other noises, and to remain within covered areas or other portions of an enclosure. The flow of water from the nozzle (20) also provides the dual benefit of cleaning one or more portions of the enclosure (10).

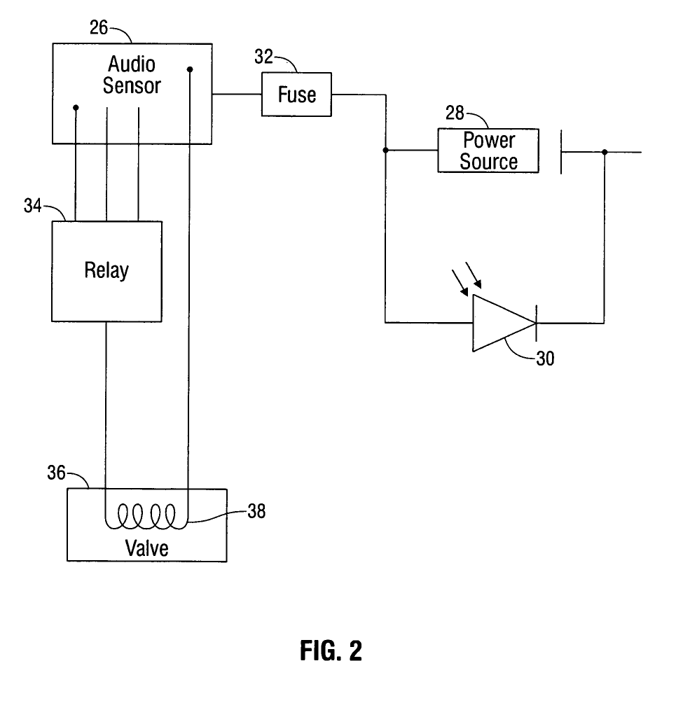

Referring now to FIG. 2, a diagram of an embodiment of various components of the present system is depicted.

An audio sensor (26) is depicted, in communication with numerous other components of the system. The audio sensor (26) can include any configuration of resistors, capacitors, grounds, switches, relays, and other electrical connections and/or contacts, coupled with a microphone or similar sound detection mechanism and sensitivity controls for providing the audio sensor (26) with a selected tolerance.

The audio sensor (26) is shown in communication with a power source (28), which can be used to provide power to the audio sensor (26) and any other system components in communication with the audio sensor (26), as necessary. While FIG. 2 depicts a single power source (28), it is to be understood that the power source (28) can include one or more power sources of any type or configuration, including rechargeable and/or replaceable batteries or similar sources of energy. In an embodiment of the invention, the power source (28) can include a 12-volt, rechargeable power source; however, the voltage and other characteristics of the power source (28) can be varied depending on the requirements of the audio sensor (26).

The power source (28) is shown operatively coupled with a photo charger (30) for recharging the power source (28). A fuse (32) is shown disposed between the power source (28) and the audio sensor (26), for preventing power irregularities from damaging any system components.

A valve (36), having a resistor (38) disposed therein, is shown in operative communication with the audio sensor (26), such that output from the audio sensor (26), responsive to detected noise, can be used to actuate the valve (36). A relay (34) is further shown, disposed in communication with the valve (36) and the audio sensor (26). The characteristics of the relay (34) can vary based on the type of power source (28) utilized. For example, a 12-volt relay would be used if the power source (28) included one or more 12-volt power sources.

It should be understood that FIG. 2 depicts an exemplary configuration of components of an embodiment of the present system, and that any arrangement and configuration including some or all of the depicted components, as well as one or more additional like or dissimilar components, can be utilized within the scope of the present invention.

The present invention thereby provides for systems and methods usable to automatically control animal noise, such as the barking of dogs, that can be applied to multiple animals simultaneously, through a single implementation of the system. The present invention is efficiently and rapidly installable, and utilizes water, rather than electrical, sonic, or chemical means to deter the affected animals, providing for humane methods that pose no danger to the animals.

While various embodiments of the present invention have been described with emphasis, it should be understood that within the scope of the appended claims, the present invention might be practiced other than as specifically described herein.

1-5. (canceled)

6. A method for controlling animal noise, the method comprising the steps of:
detecting a noise originating within an enclosure comprising an interior;
transmitting a signal responsive to the noise; and
providing water within the interior of the enclosure responsive to the signal, such that the water contacts an animal for controlling noise produced by the animal.

7. The method of claim 6, further comprising the step of preselecting a tolerance for the noise, wherein the step of detecting the noise comprises detecting a noise in excess of the preselected tolerance.

8. The method of claim 6, wherein the step of providing water within the interior of the enclosure comprises actuating a valve responsive to the signal.

9. The method of claim 6, wherein the step of providing water within the interior of the enclosure comprises preselecting a period of time for providing the water and providing the water within the interior of the enclosure for the preselected period of time.

10. The method of claim 6, wherein the step of providing water within the interior of the enclosure comprises passing the water through at least one nozzle oriented to provide the water to at least one region of the interior of the enclosure.

11-13. (canceled)

14. A method for controlling animal noise, the method comprising the steps of:
providing a water source in communication with an enclosure such that the water source is configured to provide water to an interior of the enclosure;
providing an audio sensor proximate to the enclosure and in communication with the water source;
detecting, by the audio sensor, an animal noise; and
transmitting a signal from the audio sensor to the water source responsive to detection of the animal noise, wherein the signal causes the water source to provide water to the interior of the enclosure to cause at least one animal within the enclosure to cease production of animal noise.

15. The method of claim 14, further comprising the step of providing the audio sensor with a selected tolerance, wherein the step of detecting, by the audio sensor, an animal noise comprises detecting a sound that exceeds the selected tolerance.

16. The method of claim 14, wherein the water source comprises at least one valve disposed in communication with the enclosure, and wherein the step of transmitting the signal from the audio sensor to the water source comprises transmitting the signal to said at least one valve to cause said at least one valve to open for providing water to the interior of the enclosure.

17. The method of claim 14, wherein the audio sensor, the water source, or combinations thereof comprise a timing mechanism, and wherein the step of transmitting the signal from the audio sensor to the water source causes the water source to provide water to the interior of the enclosure for a selected period of time determined by the timing mechanism.

18. The method of claim 14, wherein the water source comprises at least one nozzle disposed within the enclosure, proximate to the enclosure, or combinations thereof, wherein the step of providing the water source into communication with the enclosure comprises orienting said at least one nozzle to provide water to one or more regions of the enclosure with a force sufficient to deter animal noise, to cause an animal to move to another region within the enclosure, to clean one or more regions of the interior of the enclosure, or combinations thereof.

19. A method for controlling animal noise, the method comprising the steps of:
providing a water source in communication with at least one valve and with an enclosure comprising an interior such that the water source is configured to provide water to the interior of the enclosure;
providing an audio sensor proximate to the enclosure and in communication with the water source, said at least one valve, a transmitter, or combinations thereof;
providing the audio sensor with a selected tolerance;
detecting, by the audio sensor, an animal noise that exceeds the selected tolerance;
transmitting a signal from the transmitter to the water source, said at least one valve, or combinations thereof, wherein the signal causes said at least one valve to open such that the water source provides water to the interior of the enclosure to cause at least one animal within the enclosure to cease production of animal noise

20. The method of claim 19, wherein the audio sensor, the water source, said at least one valve, the transmitter, or combinations thereof further comprise a timing mechanism, and wherein the step of transmitting the signal causes the water source to provide water to the interior of the enclosure for a selected period of time determined by the timing mechanism.

21. The method of claim 19, wherein the water source comprises at least one nozzle disposed within the enclosure, proximate to the enclosure, or combinations thereof, wherein the step of providing the water source into communication with the enclosure comprises orienting said at least one nozzle to provide water to one or more regions of the enclosure with a force sufficient to deter animal noise, to cause an animal to move to another region within the enclosure, to clean one or more regions of the interior of the enclosure, or combinations thereof.
